(19) United States
(12) Patent Application Publication
(10) Pub. No.: US 2016/0310901 A1
(43) Pub. Date: Oct. 27, 2016

(54) MODULAR MEMBRANE STACK DESIGN

(71) Applicant: GENERAL ELECTRIC COMPANY, New York, NY (US)

(72) Inventors: Harikrishnan RAMANAN, Singapore (SG); Li May GOH, Singapore (SG); Varshneya SRIDHARAN, Singapore (SG); Vinay Sonu SAWANT, Singapore (SG)

(21) Appl. No.: 15/106,003

(22) PCT Filed: Aug. 20, 2014
(86) PCT No.: PCT/US2014/051880

§ 371 Date: Jun. 17, 2016

Related U.S. Application Data
(60) Provisional application No. 61/918,727, filed on Dec. 20, 2013.

(51) Int. Cl. B01D 61/50; B01D 65/10; B01D 61/52; B01D 63/08

(52) U.S. Cl. CPC B01D 61/50; B01D 63/082; B01D 65/104; B01D 61/52; B01D 2313/56

(57) ABSTRACT

A membrane stack may be used, for example, in an electrodialysis or other electrically driven membrane separation device. The stack has a plurality of modules, each containing a number of membranes and spacers bundled together. A module can be removed from the stack, for example for diagnosis or repair by sliding the module out of the stack in a direction parallel to the plane of a membrane or spacer in the stack. A banding mechanism is described for compressing a stack but can be released to allow the stack to be dis-assembled. The banding mechanism is also capable of lifting at least an upper end plate or electrode from the stack. Ports communicate with parts of a stack and may be used to perform diagnostic tests. In an embodiment, the stack has at least two modules as described above and each of the two modules has at least one port.

### CROSS-REFERENCE TO RELATED APPLICATIONS

This application is a national stage application under 35 U.S.C. §371(c) of prior filed, co-pending PCT application serial number PCT/US2014/051880, filed on Aug. 20, 2014 which claims priority to U.S. Provisional Application No. 61/918,727, titled “MODULAR STACK DESIGN”, filed on Dec. 20, 2013. The above-listed applications are herein incorporated by reference.

### FIELD

Embodiments of the invention relate to membrane stacks, for example as used in electrodialysis or other electrically driven membrane separation devices, and to methods of making them.

### BACKGROUND

In typical plate and frame type electrically driven membrane separation devices, a stack is built up of alternating ion exchange membranes and spacers. The spacers electrically insulate the ion exchange membranes from each other and provide flow channels between them. Gaskets are provided between the spacers and the membranes around the flow channels. In an electrodialysis (ED) stack, including ED variants such as electrodialysis reversal (EDR) and reverse electrodialysis (RED), the ion exchange membranes alternate between anion and cation exchange membranes. In other types of stacks (Donnan or Diffusion Dialysis) there may be only cation exchange membranes or only anion exchange membranes. In electro-deionization (EDI) or continuous electrodialyis (CEDI) stacks there are alternating anion and cation exchange membranes and ion exchange resin in the flow channels of some or all of the spacers. In a further extension the ion exchange membranes in the ED stack may be replaced with high surface area electrodes producing a capacitive deionization stack.

United States Publication Number US 2010/0326833 describes a membrane package comprising a plurality of membranes, wherein the membrane package is adapted to facilitate a feed stream flow having a process stream flow wherein the hydrodynamic resistance of the feed stream flow is substantially the same as the hydrodynamic resistance of the process stream flow.

### BRIEF DESCRIPTION

The following introduction is intended to introduce the reader to the detailed description to follow and not to limit or define the claims.

One embodiment of the present invention relates to a membrane stack, for example for use in an electrodialysis or other electrically driven membrane separation device. The stack has a modular design wherein a number of membranes and spacers (which is less than the total number of membranes and spacers in the entire stack) are bundled together to form a sub-assembly, alternatively called a module. The module is removable from the remainder of the stack, for example for diagnosis or repair. A full stack may have a plurality of modules, each of which is separately removable. In an embodiment, the modules can be removed by sliding them out of the stack in a direction parallel to the plane of a membrane or spacer in the stack.

Another embodiment of the present invention relates to a membrane stack having a reversible banding mechanism for compressing a stack. The stack contains membranes and spacers, in the form of modules as described above, with end plates, electrodes and any other elements ordinarily assembled into a stack. The banding mechanism may compress the stack by way a mechanical, pneumatic or electrical mechanism. The compression can be released to allow the stack to be dis-assembled, for example by removing a module. In an embodiment, the banding mechanism is also capable of lifting at least an upper end plate or electrode from the stack.

Another embodiment of the present invention relates to a membrane stack having ports in communication with parts of the stack. The ports may be used to perform diagnostic tests, such as a leak test using a dye solution or measurements using a probe such as a pH or conductivity probe. In an embodiment, the stack has at least two modules as described above and each of the two modules has at least one port.

### BRIEF DESCRIPTION OF THE DRAWINGS

FIG. 1 shows a schematic isometric view of a module.

FIG. 2 shows a schematic isometric view of a stack having modules as in FIG. 1.

FIG. 3 is a schematic isometric view of another stack having a frame and modules in the form of sliding trays.

FIG. 4 shows a schematic side view of a two electrode configuration for a stack.

FIG. 5 shows a schematic side view of a three electrode configuration for a stack.

FIG. 6A shows a first option for the frame of FIG. 3.

FIG. 6B is an enlargement of part of FIG. 6A.

FIG. 7A shows a second option for the frame of FIG. 3.

FIG. 7B is an enlargement of part of FIG. 7A.

FIG. 8A shows a tray for use with the frame of FIG. 6A.

FIG. 8B is an enlargement of part of FIG. 8A.

FIG. 9A shows a tray for use with the frame of FIG. 7A.

FIG. 9B is an enlargement of part of FIG. 9A.

FIGS. 10A and 10B show conceptual designs for internal frames or housings.

FIG. 11 shows a side view of a binding mechanism for use with a two electrode configuration.

FIG. 12 shows a side view of a binding mechanism for use with a three electrode configuration.

FIG. 13 shows a detail of part of the tray of FIG. 3.

### DETAILED DESCRIPTION

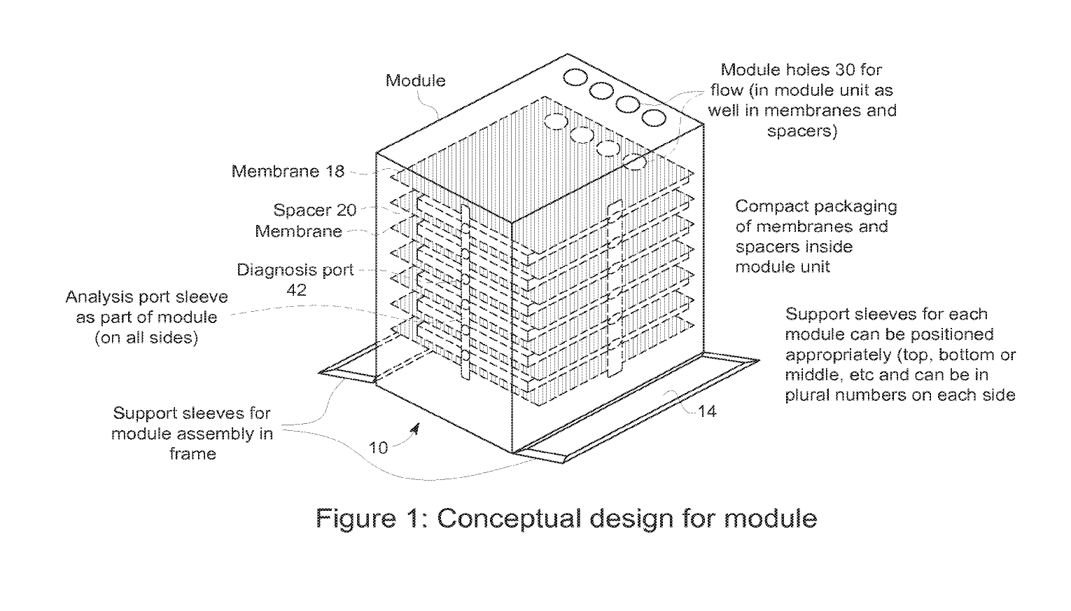

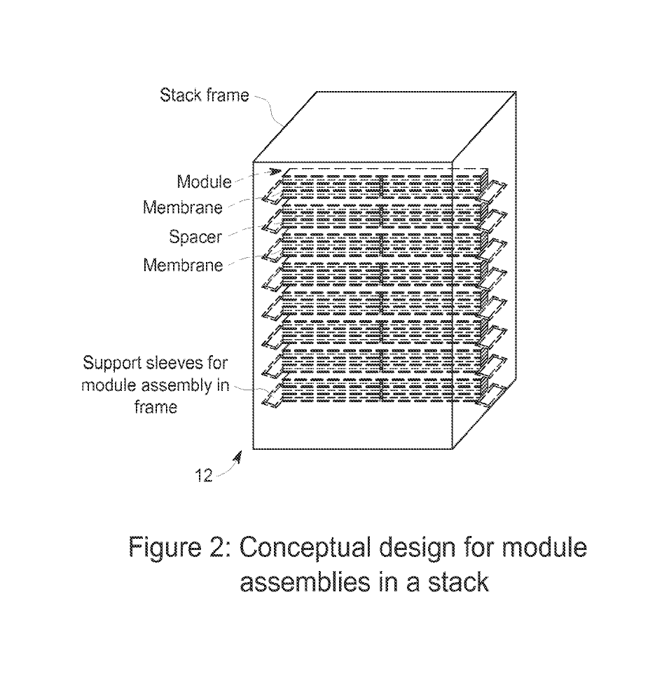

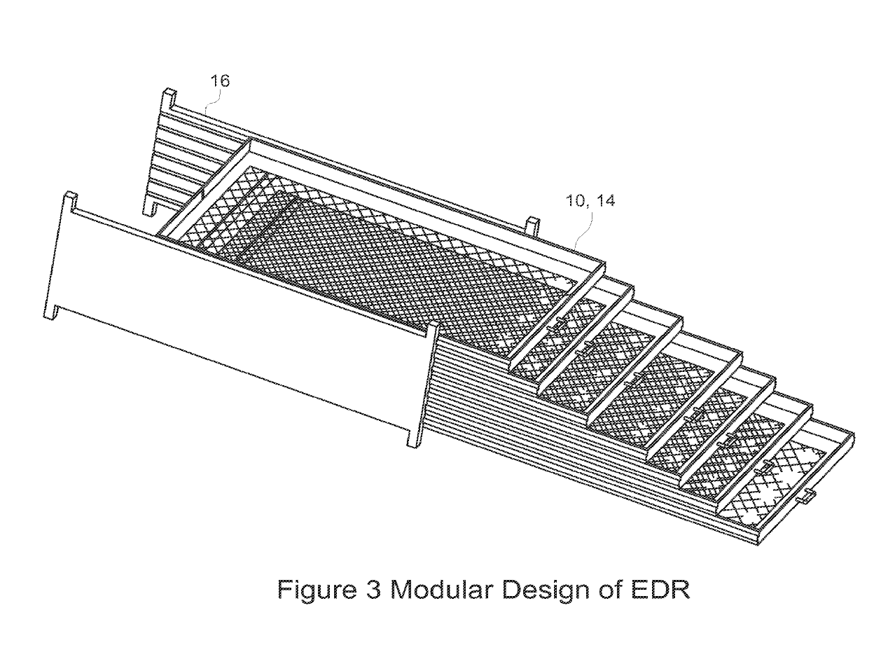

FIGS. 1 and 2 show conceptual designs for a membrane module 10 and stack 12. FIG. 3 shows a more detailed example in which each module is in the form of a tray 14 that slides relative to an internal, or first, frame 16. The stack 12 may be used, for example, in an electrodialysis or other electrically driven membrane separation device.

The stack 12 has a modular design wherein a number of membranes 18 and spacers 20 (which is less than the total number of membranes and spacers in the entire stack) are bundled together to form a sub-assembly, alternatively called a module 10 and shown conceptually in FIG. 1. The module 10 including the tray 14 is removable from the remainder of the stack 12, for example for diagnosis or repair. A full stack 12, as shown in FIG. 2, may have a plurality of modules 10, each of which is separately removable. The modules 10 can be removed by sliding them out of the stack 12 in a direction parallel to the plane of a membrane 18 or spacer 20 in the stack 12, for example as shown in FIG. 3.

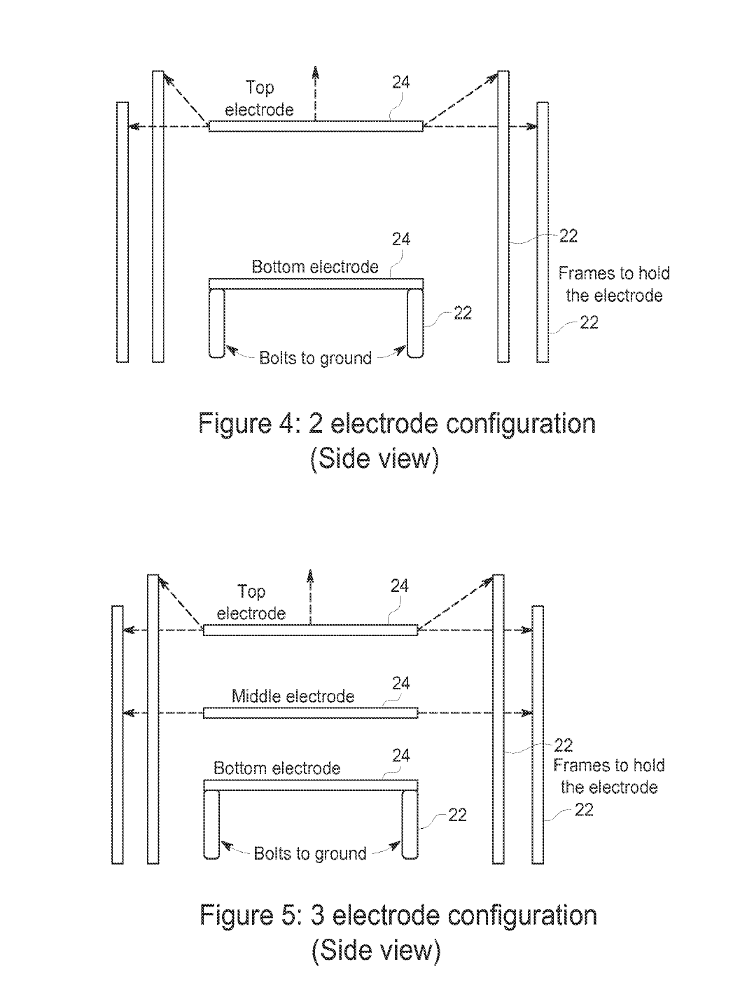

Referring to FIGS. 4 and 5, an external, or second, frame 22 holds the electrodes 24. Alternatively, the external frame 22 may hold the end plates, or both the electrodes and the end plates, or the electrodes may be part of the end plates. There may be two or three electrodes 24 as shown or more electrodes. The external frame 22 allows the upper electrode 24 to move vertically while holding a desired lateral position. As shown, the bottom electrode 24 (or end plate etc.) is bolted to the ground such that when the top electrode raised or lowered the stack 12 is compressed or released from compression respectively. Alternatively the external frame 22 may span between the upper and lower electrode 24.

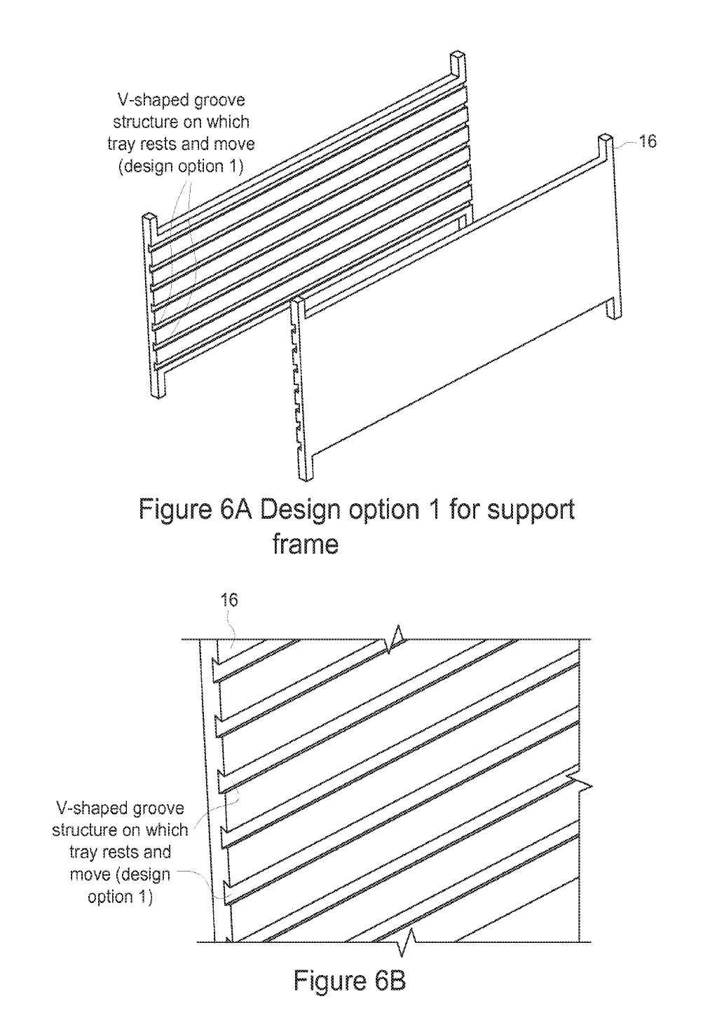

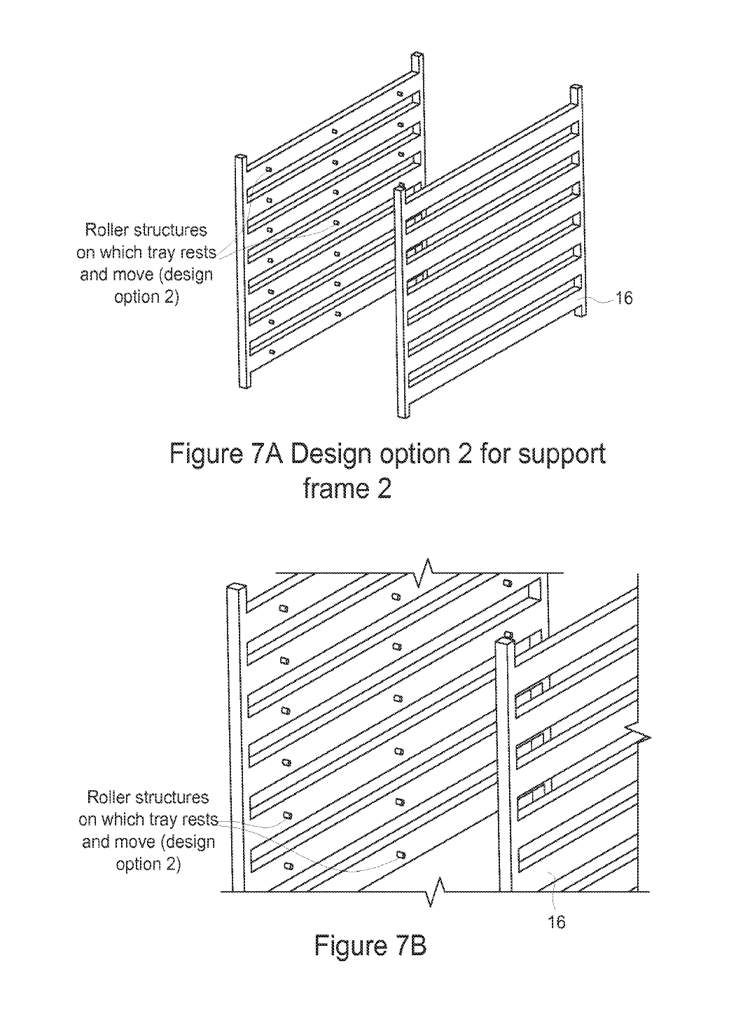

FIGS. 6A, 6B, 7A and 7B give more details of alternative structures for the internal frame 16. The internal frame may be held in place by the external frame 22 to give the system more mechanical support and stability. An end plate may be part of the external or internal frame.

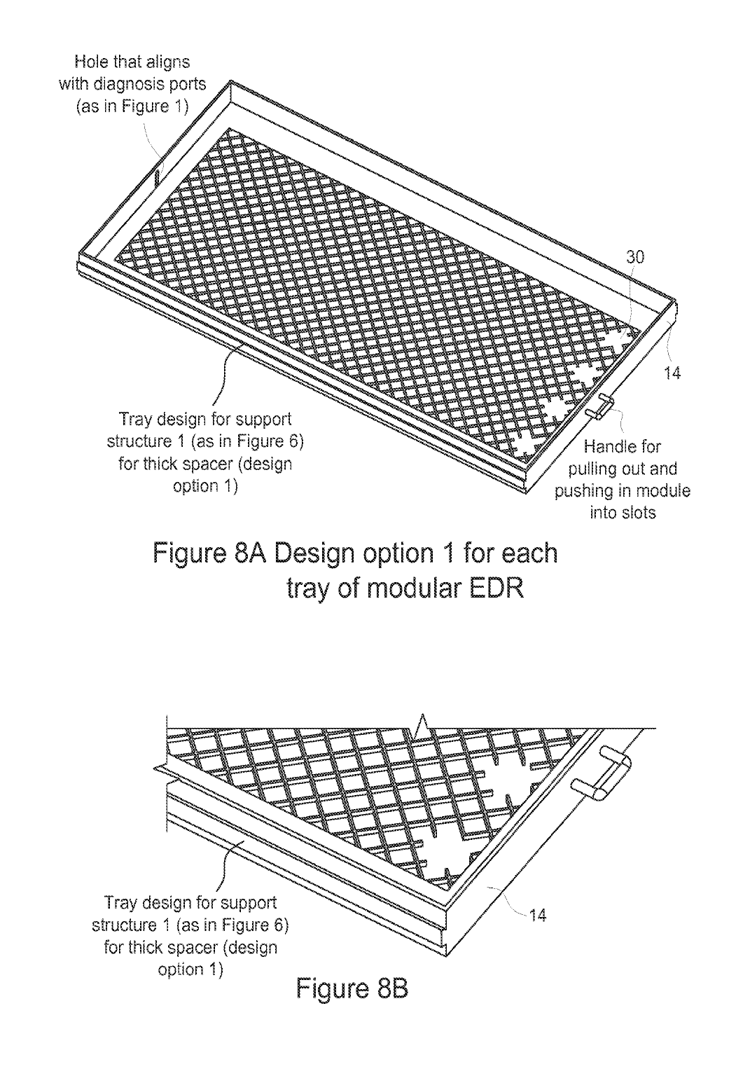

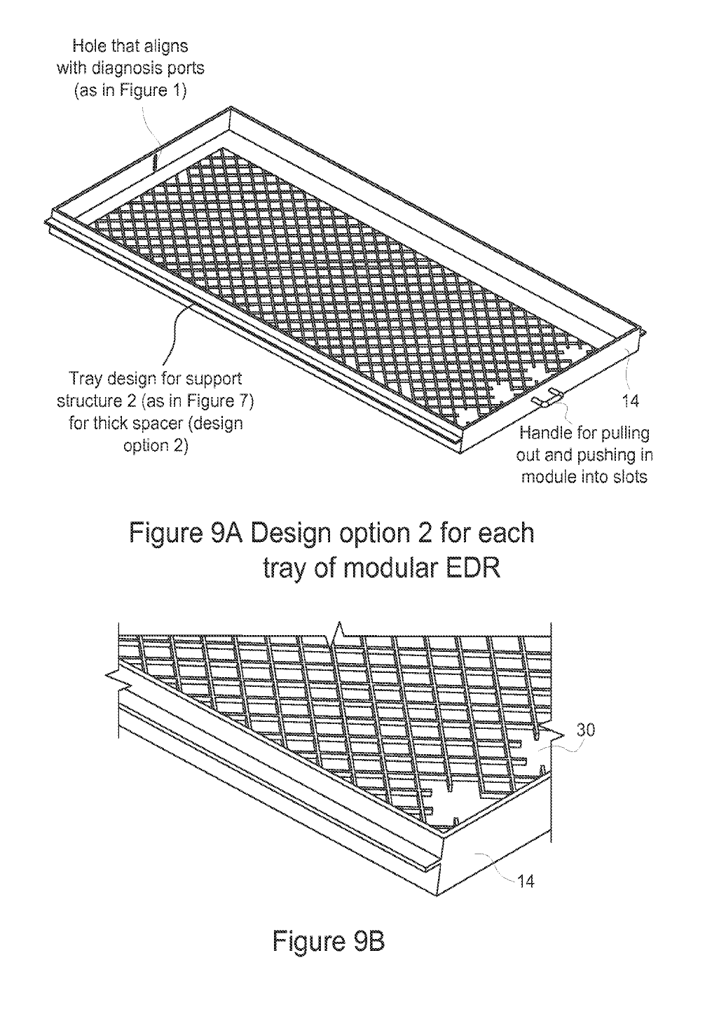

FIGS. 8A, 8B, 9A and 9B show tray form modules 10. Only a supporting structure, alternatively called a module frame 14, is shown in these figures. The membranes and spacers of FIG. 1 are placed on the supporting structure to complete the modules 10. In an embodiment, the modules 10 include a thick spacer. Optionally, the thick spacer may be part of the module components shown in FIG. 1. The modules 10 fit within the electrode gap of a stack.

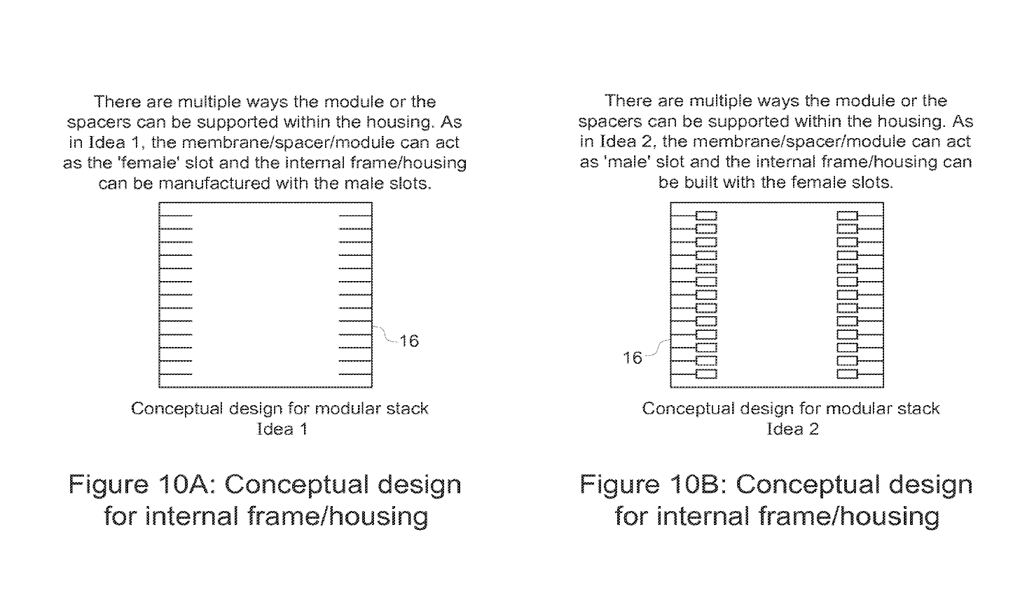

In an embodiment, each module 10 includes a plurality, for example 10 or 20 or more, of membrane cell pairs on top of each other. Each cell pair in an electrodialysis stack has an anion exchange membrane and a cation exchange membrane separated by a spacer. The supporting structure 14 may be made, for example, of metal or plastic. The cell pairs are loaded or arranged into the supporting structure. The internal frame, alternatively called a housing, supports the modules. As shown in FIG. 10, the internal frame 16 and modules 10 may cooperate through a male-female slot combination.

The supporting structures 14 of the modules 10 have manifold holes 30 in appropriate locations to enable flow through the stack 12. A plurality of modules 10 makes up a stack 12. The stack 12 may also have electrodes and end plates as required for a particular device or process.

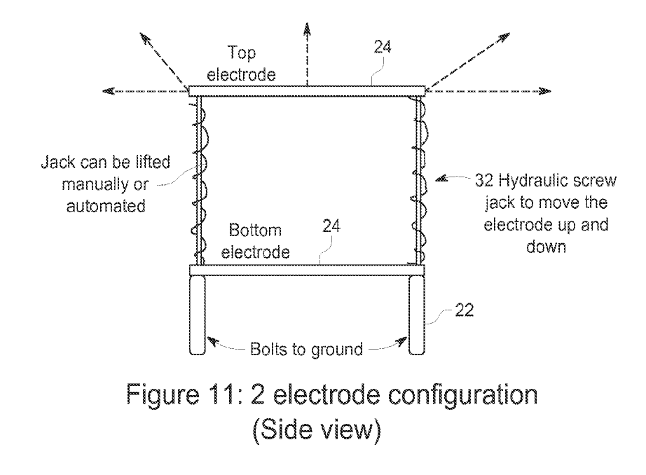

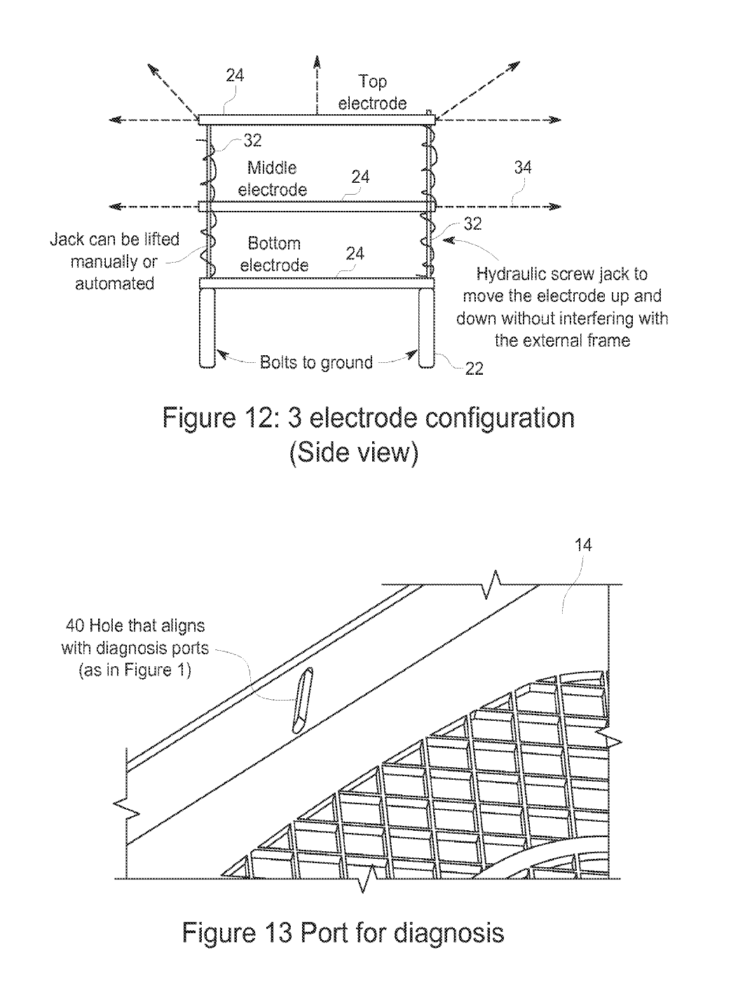

FIGS. 11 and 12 show a binding mechanism 32 for the stack. The binding mechanism controls the motion of the electrodes and/or endplates relative to each other. This helps with inserting the modules. Appropriate hydraulic, mechanical, electrical or other mechanisms may be used. The mechanism 32 allows for height adjustment and seating of the electrode and endplate assembly 24 with respect to the internal frame 16 and the modules 10. A middle electrode is held in place, for example by external cables 34 attached to the external frame. The bottom endplate 24 may be bolted to the floor if the device is not a mobile unit. Optionally, frames, supporting structures or modules may also be controlled by hydraulic, mechanical, electrical or other mechanisms.

An electrodialysis device has modules 10, optionally with supporting structures or frames 14, end plates and electrodes. These components are assembled such that modules can be independently removed for diagnostic analysis of the membranes and/or spacers.

A module 10 can be inserted or removed from a stack 12 by way of, for example, grooves, rollers, slots, or other manual or automatic stacking mechanisms. To dismantle a stack 12, the electrodes or end plates are first disengaged or de-compressed. One or more individual modules 10 may then be removed. To assemble a stack 12, the modules 10 are placed in the slots of the internal frame and then the end plates or electrodes are engaged or compressed.

As shown in FIG. 13, the module supporting structures may have one or more holes 40 that align with diagnosis or sampling ports in communication with the cells of the module 10. For example, at each module appropriate ports or holes may be provided to allow collecting water samples for inter-module data analysis or trouble shooting. The ports 42, shown in FIG. 1, may be used to perform diagnostic tests, such as a leak test using a dye solution or measurements using a probe such as a pH or conductivity probe. In an embodiment, the stack 12 has at least two modules 10 as described above and each of the two modules 10 has at least one port 42.

To help avoid leaks between modules 10, the module base may be designed as a spacer material to enable flow but also sealing to the membranes above and below it. Alternatively, a thick spacer can be provided with the module supporting structure to help avoid leaks between modules.

The devices described above at least provide a useful alternative membrane stack. Further one or more embodiments may have one or more benefits. For example, a conventional process for diagnosing a problem with a stack involves manually dismantling the stack and inspecting the individual membranes. Using a modular design, one or more selected modules may be removed for diagnosis independently from the rest of the stack. In a conventional stack diagnosing an individual membrane requires dismantling the stack until that membrane can be exposed. Using a modular design with diagnostic ports provides the opportunity to test selected modules of the stack to identify which membrane, membrane pair or spacer has a problem. In particular, with a conventional stack finding and correcting a faulty membrane at the bottom of the stack requires dismantling the entire stack from the top. This results in long down times and a risk that the stack will not be re-assembled properly. With a modular design, a faulty module may be replaced with a new module while the faulty module is inspected further. This reduces down time and facilitates on site repair of a faulty stack by module replacement with repair of the defective module done off site. The electrode or end plate are often heavy and can require a fork lift to lift them for an on-site repair. The banding mechanism, for example fixing the bottom end plate and using a jack to lift the top end plate, allows for faster maintenance of the stack and avoids the need for an on-site fork lift. The stack is made easy to dis-assemble despite its movable top end plate and electrode by fixing the top end plate or electrode to a frame, for example with cables, and moving the top end plate or electrode by a jack. Optionally the modular design allows installing diagnostic tools at any membrane or cell pair or at an electrode.

Aspects of the invention may also be applied to electrochemical cells such as electrolysis cells or fuel cells, membrane filtration devices or other flat sheet membrane based stacks.

This written description uses examples to disclose the invention, including the preferred embodiments, and also to enable any person skilled in the art to practice the invention, including making and using any devices or systems and performing any incorporated methods. The patentable scope of the embodiments of the invention are defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A membrane stack comprising,
a number of membranes and spacers which is less than a total number of membranes and spacers in the stack assembled together to form a module,
wherein the module is removable from the remainder of the stack.

2. The membrane stack of claim 1 comprising a plurality of modules, each of which is separately removable.

3. The membrane stack of claim 1 or 2 wherein at least one of the modules is removable from the stack by sliding the module out of the stack in a direction parallel to the plane of a membrane or spacer in the stack.

4. The membrane stack of claim 3 further comprising a first frame wherein the first frame supports the sliding module.

5. The membrane stack of claim 4 wherein the sliding module comprises a tray that cooperates with the first frame.

6. The membrane stack of claim 5 wherein the tray cooperates with the first frame by way of slots or rollers.

7. The membrane stack of claim 5 wherein the tray comprises a spacer.

8. A membrane device comprising,
a stack including membranes and spacers, and
a mechanism operable to reversibly compress the stack.

9. The membrane device of claim 8 wherein the stack is as described in claim 1.

10. The membrane device of claim 8 wherein the mechanism comprises a mechanical, pneumatic or electrical jack.

11. The membrane device of claim 8 wherein the mechanism is adapted to lift an upper electrode or upper plate of the stack.

12. The membrane device of claim 11 comprising a second frame, wherein the upper electrode or upper plate is connected to the second frame.

13. A membrane stack comprising,
a number of membranes and spacers,
one or more ports in communication with one or more of the membranes or spacers.

14. The membrane stack of claim 13 comprising a sleeve connecting a plurality of the ports together.

15. The membrane stack of claim 13 wherein the stack comprises at least two modules as described in claim 1 and each of the modules has at least one port.

16. The membrane stack of claim 2 wherein at least one of the modules is removable from the stack by sliding the module out of the stack in a direction parallel to the plane of a membrane or spacer in the stack.

17. The membrane stack of claim 6 wherein the tray comprises a spacer.

18. The membrane device of claim 9 wherein the mechanism comprises a mechanical, pneumatic or electrical jack.

19. The membrane stack of claim 14 werein the stack comprises at least two modules as described in claim 1 and each of themodules has at least one port.
